(19) United States
(12) Patent Application Publication
(10) Pub. No.: US 2008/0195965 A1
(43) Pub. Date: Aug. 14, 2008

(54) SYSTEM FOR THE DISTRIBUTION OF DATA HANDLING FUNCTIONS WITH SEPARATION AND ISOLATION OF THE HANDLING OF PERSONALLY IDENTIFIABLE DATA FROM THE HANDLING OF OTHER DATA

(76) Inventor: Ori Pomerantz, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/672,531

(22) Filed: Feb. 8, 2007

(51) Int. Cl. G06F 3/048

(52) U.S. Cl. 715/780

(57) ABSTRACT

A computer controlled data entry system for isolating user-sensitive personally identifiable entered data from general entered data comprising an implementation for requesting the entry of user data into an entry document, a first section in the entry document for all entered user-sensitive personally identifiable data, a second section in the entry document for all general entered data, and an implementation for processing the entered personally identifiable data in isolation from the general entered data.

### TECHNICAL FIELD

The present invention relates to handling and processing of data entered into a computer controlled system, and particularly in such systems that must protect sensitive and confidential personally identifiable data in a distributed data processing environment; particularly when the processing of data is outsourced.

### BACKGROUND OF RELATED ART

The past generation has been marked by a rapid expansion of industries involved in the marketing and distribution of virtually all goods and services over the Internet or World Wide Web (Web) (terms are used interchangeably herein) or like networks. With the instant accessibility of data processing by people through the country and the world, there is an increasing trend in the processing or handling of information to outsource the information handling and processing of an originating business organization to businesses that specialize in particular data handling functions.

With this trend in outsourcing, many service organizations in the insurance, banking and particularly the health industries have been dramatically reducing in-house staffs in favor of outsourcing organizations that perform limited information handling functions.

While such outsourcing has been beneficial to service businesses in cost reduction, it has created serious and valid concerns on the part of the individual consumers of such services who are required to enter great amounts of personal and confidential (sensitive) data, i.e. personally identifiable information as required by the businesses in order to effectively perform their services.

Accordingly, business organizations are required to protect such personally identifiable data. This personally identifiable data, such as medical information, becomes sensitive only when connected to the user. In addition, if an organization in such critical areas as banking or health/medicine improperly handles data in a manner that compromises this personally identifiable data, the reputation of such an organization may be so significantly tarnished that its business suffers significant damage.

This situation presents business organizations in industries where a high degree of trust in data handling is required with a dilemma. They may continue to do virtually all data handling in house with more costly higher level employees in the traditional way. This will affect their cost competitiveness in the market place. Alternatively, such organizations may outsource many data handling functions to lower cost outsourcing businesses, with lower standards and lower skill level employees, and take the risk that the outsourced data may be compromised.

### SUMMARY OF THE PRESENT INVENTION

The present invention provides an implementation that enables a business organization to maintain and protect such personally identifiable data while dynamically selecting and outsourcing information for outside handling that is unlikely to result in compromising the personally identifiable user sensitive data.

The invention provides a computer controlled data entry system for isolating personally identifiable user sensitive entered data from general entered data comprising the combination of means for requesting the entry of user data into an entry document, wherein a first section in the entry document is for personally identifiable data and a second section in the entry document is for other data, and means for respectively transferring the first section of the document to a first data processor and the second section of the document to a second data processor. There are means for processing the personally identifiable data in isolation from the other data by the first and second processors to respectively produce processed personally identifiable data and processed other data. At this point there are means for relating the processed personally identifiable data and the processed other data, but in isolation from said first and second processors.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic view of a data entry form that a patient may be required to fill out at a visit to a physician's facility, arranged to suit the present invention;

FIG. 2 is the same diagrammatic view of the form of FIG. 1 as would be presented on a user interactive computer display to solicit user data for the physicians, office, but with the user-sensitive, i.e. personally identifiable information, distinguished from the general inquiries through colored boundaries;

FIG. 3 is a block diagram of a generalized view of a network set up for the distribution of data handling functions between two isolated and unconnected data handling providers respectively for the general and the personally identifiable data according to present invention;

FIG. 4 is a block diagram of a basic generalized data processing system including a central processing unit (CPU) that may be used at the business organization computer terminals or the server terminals of outsourced data handling providers in the implementation of this invention;

FIG. 5 is an illustrative flowchart describing the setting up of the elements of a program according to the present invention; and

FIG. 6 is a flowchart of an illustrative run of the program set up in FIG. 5.

### DETAILED DESCRIPTION OF THE PREFERRED EMBODIMENT

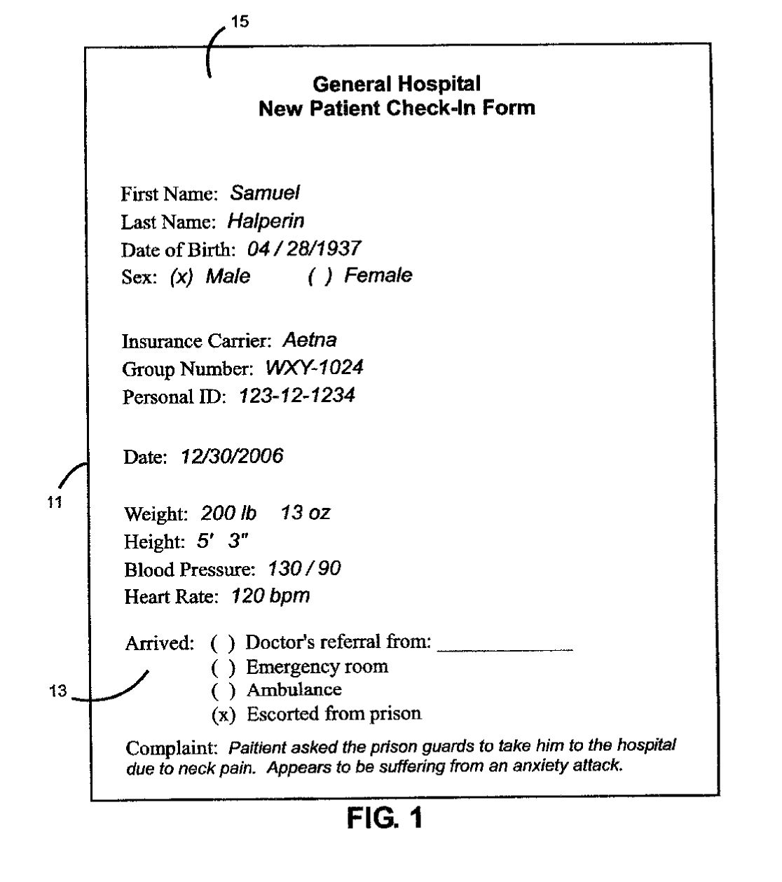

Referring to FIG. 1, there is shown a diagram of a data entry form soliciting both user-sensitive, i.e. personally identifiable, and general information from the user. The form has been simplified to a single page for purposes of illustration. The form 11 that solicits information from a patient at a medical/healthcare facility may be many pages in actual length. For the purpose of illustrating this invention, a medical form has been selected because medical data may be particularly personally identifiable or user-sensitive. Much of the information is protected by law as doctor-patient privileged. However, the same functions of the present invention would be applicable to financial, religious, political, professional and family information.

The form shown may be a paper form that is filled out off-line by the user and then scanned into the data handling system. The form may also be directly filled in by the user on-line on a computer controlled display. In the form shown in FIG. 1, the form is set up so that the user-sensitive personally identifiable information solicited from the user is in one section, 15, of the form, and the other information requested is concentrated in another section 13. It should be noted that other information in section 13 may still be confidential and sensitive information with respect to the user or the medical facility. However, it is the personally identifiable data in section 15 that may be a user serial number or, for example, driver's license number, that will connect the user to the sensitive data in section 13. It is this personally identifiable information in section 15 that must remain isolated from the information in section 13 in order to protect the user.

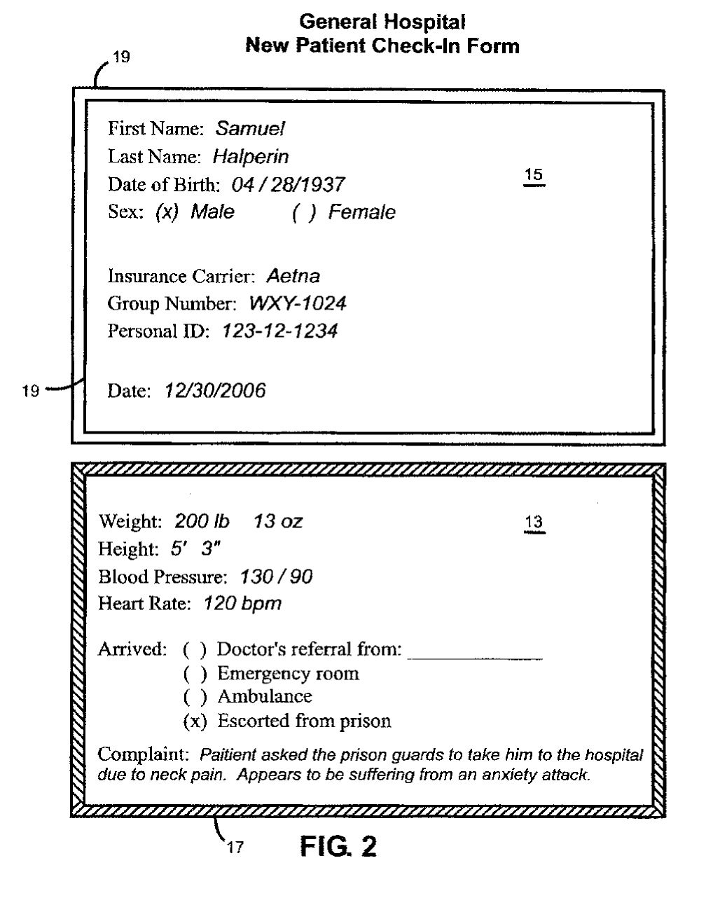

The personally identifiable data need not be in a specified section of the data entry form. The questions requesting personally identifiable information may be presented interspersed with questions for general data. In the latter situation, the process of the invention will recognize and distinguish questions soliciting personally identifiable information from those requesting general information. This distinguished information will be subsequently organized in a form shown in FIG. 2 wherein the section containing the general information 13 is surrounded by a peripheral boundary wall 17 that isolates section 13 from the personally identifiable information 15 surrounded by isolating boundary wall 19. Irrespective of the data entry process, the form 11 in FIG. 2 may be displayable to the user entering data so that the user may feel comfortable that the personally identifiable data 15 is being isolated for protection. The two boundaries 17 and 19 may be color coded so that the personally identifiable information 15 may be isolated from the general information in section 13. As will be hereinafter described, in order to maintain isolation of personally identifiable information in section 15 from the general information in section 13, each is assigned an independent identifier, and each identifier cannot be related to the other by any information handling provider respectively processing one or the other of the general or personally identifiable data groups. The only point that the distinct identifiers for both data groups may be correlated is at the originating medical facility for which the entered data is being processed when the outputs of the information handling providers are returned to the originating facility.

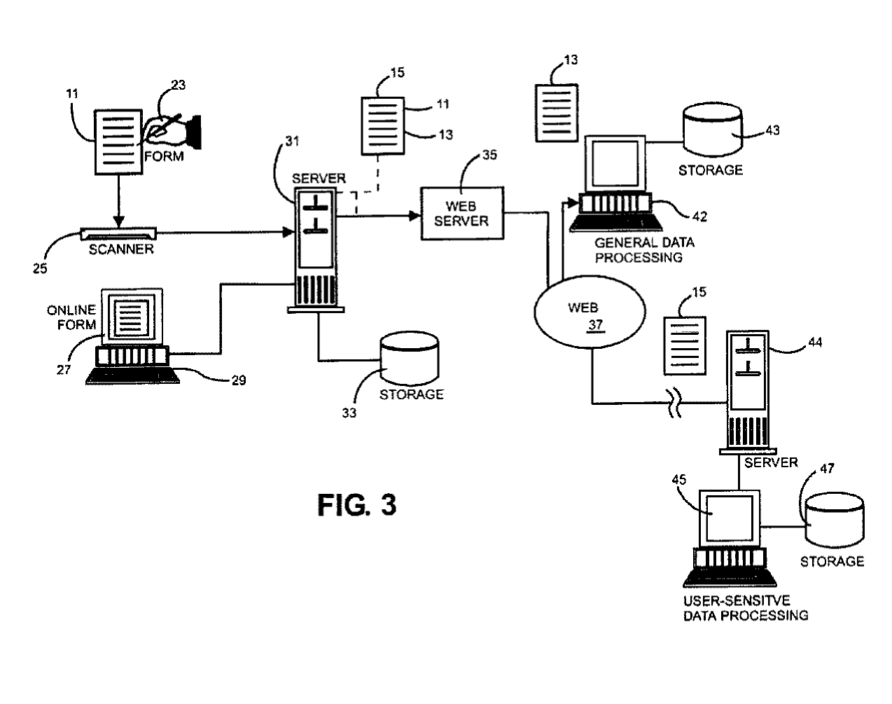

Referring now to FIG. 3, there is shown a diagram of a generalized view of a network set up for the distribution and handling of the illustrative medical information by two different and isolated information handling providers.

In the illustrative medical facility, the patient or user may manually 23 fill out the form 11 requesting both general and personally identifiable information. The form is processed through a scanner 25 at the facility into a server 31 that supports the facility. Alternatively, the information requested may be entered by the user directly into on-line form 11 on computer 29 controlled display 27, and also entered into facility server 31. One complete copy 11 of the form should be stored under the control of server 31 at the database 33 at the facility including general information section 13, personally identifiable section 15 with appropriate identifiers for each information section. This will be the last point in the process where the two sections 13 and 15 are correlated. Once these two sections are distributed for further handling to information handling providers, there will be no possible correlation of the two sections, and they will be processed independently and in isolation from each other.

The purpose and key to the invention is the unrelatable separation of the two sections. The personally identifiable information in section 15, i.e. the serial number of the user, is only compromised as to the user when related to the information in section 13. Thus, the invention depends on the unrelatable separation of the two sections.

In this connection, it is noted that doctors and medical facilities are required to provide general information for public health demographic purposes that need not be related to specific patients. In the cases of AIDS or tuberculosis, doctors are required to maintain and report data to public health facilities. This information, which is user-sensitive, would only become compromised when personally identified with the user.

There may be many other instances where medical facilities are required to process patient information for public health reasons, e.g. reports on drug use or adverse effects of various medical procedures, that must not be related to particular patients. Accordingly, there is the requirement of unrelated isolated processing of the two separate groups of information.

Great burdens imposed upon medical offices in the way of form upon form that must be completed for each patient, Medicaid, Medicare, several different insurance forms (each patient may get insurance from several carriers), prescription provider forms, various government and Public Health forms. Smaller medical facilities cannot afford the costs of maintaining the staff to process all of these forms and other required documents. Accordingly, in the medical field, as well as in other fields and technologies where similar needs exist, there has been a trend toward outsourcing administrative “paperwork” including further data entry to a variety of information handling providers that perform these functions at various levels of exactitude. It is in such an outsourcing environment that the present invention functions most effectively.

The server 31 accesses the web 37 through Web server 37, and transmits the section 15 with user-sensitive personally identifiable data to a data handling service provider 45 of high quality, reliability and trust that will process the user-sensitive data in a trustworthy manner via provider server 44. During the information handling process by provider 45, the personally identifiable data section 15 will be stored in database 47 under control of the provider server 44. Any data handling information and data product produced by provider 45 will be stored in database 47 to be appropriately distributed according to the business needs of the originating facility (at server 31). On the other hand, in line with the business need for cost reduction, the general but not personally identifiable data section 13 is transmitted to a lower cost general data processing provider 42 via Web server 35 and Web 37. This general information will be stored in database 43 under control of the provider 42, and any data handling information and data product produced by provider 42 will also be stored in database 43. This produced data may be appropriately distributed according to the business needs of the originating facility. Data handling provider 42 need not be of the same high quality and reliability as provider 45. However, since the general data is personally identifiable data, this lesser facility may adequately fulfill the data handling needs as to general data without presenting any problems in protecting the personally identifiable data.

It must be emphasized that during this information handling through providers 42 and 45, data sections 13 and 15 remain completely isolated from each other. The sections have separate identifiers and the respective providers 42 and 45 are completely unaware of the contents of the respective sections 13 or 15 that are not being processed by the provider. It is only when data or work product resulting from the handling of the data is returned to server 31 of the originating facility that the data from the respective sections may be combined at the originating facility. Server 31 has the additional data necessary to finally relate the two identifiers and, thus, the information represented by the identifiers back at the medical facility.

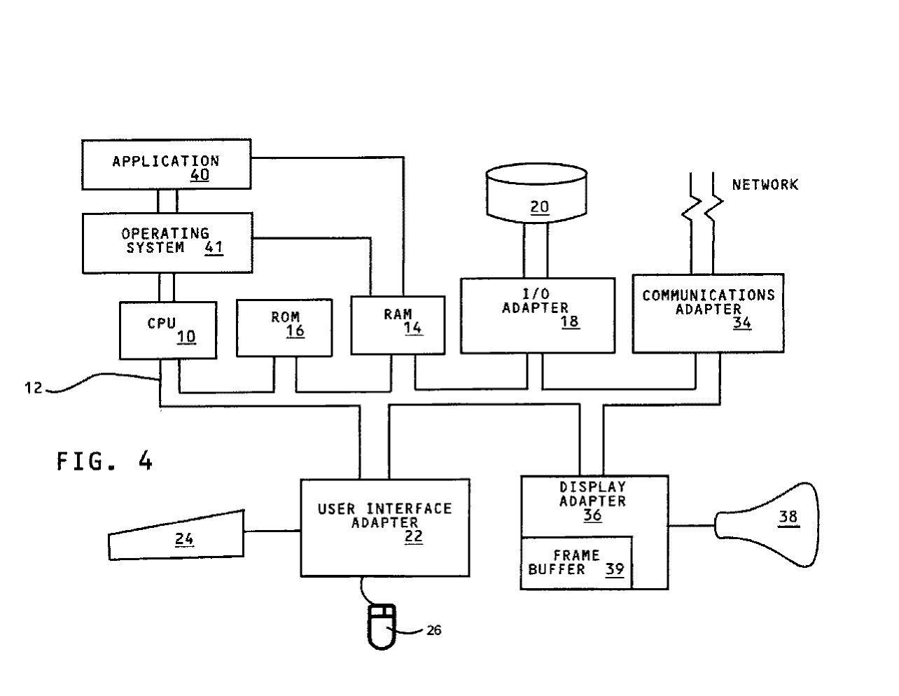

Reference is now made to FIG. 4 that represents a typical data processing display system that may function as the computer controlled display station 29 or computer terminals at providers 42 and 45, or servers such as servers 31 or 44. A CPU 10, such as one of the PC microprocessors or workstations, e.g. System pSeries™ available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX™ operating system available from IBM; Microsoft's WindowsXP™, as well as various other UNIX and Linux operating systems. Application programs 40, controlled by the system, are moved into and out of the main memory Random Access Memory (RAM) 14. These programs include the programs of the present invention for isolating personally identifiable entered data from general entered data when the data is distributed for processing by outsourced information handling providers. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20 to provide the storage of the database of the present invention. Communications adapter 34 interconnects bus 12 with an outside network enabling the data processing system to communicate with other such systems over networks including the Web. I/O devices are also connected to system bus 12 via user interface adapter 22 and display adapter 36. Keyboard 24 and mouse 26 are all interconnected to bus 12 through user interface adapter 22. Where, as in this illustrated embodiment, the controlling computer is a display computer, then display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

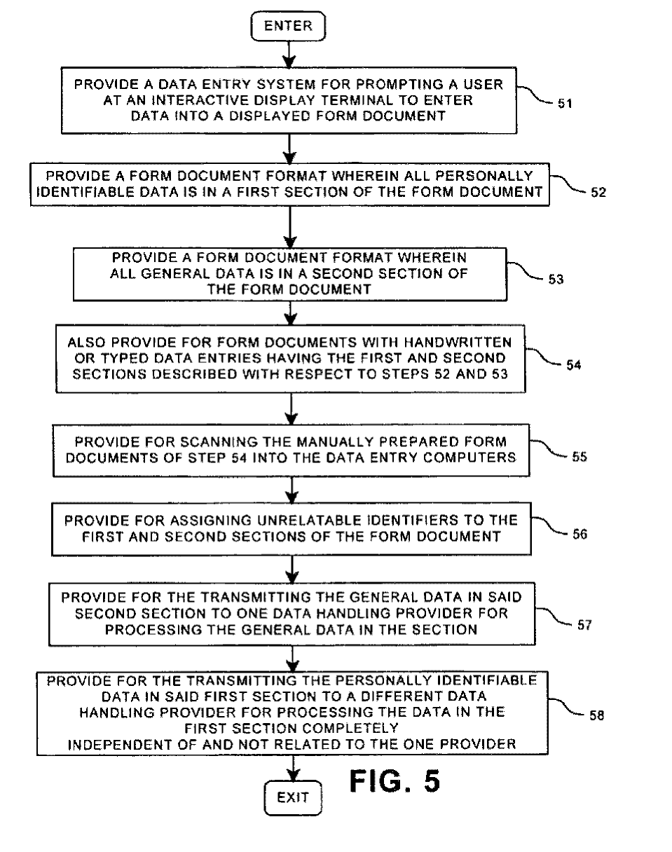

FIG. 5 is a flowchart showing the development of a process according to the present invention for isolating user-sensitive entered data from general entered data when the data is distributed for processing by outsourced information handling providers. A data entry system is provided for prompting a user at an interactive display terminal to enter data into a displayed form document, step 51. Provision is made for a form format wherein all personally identifiable data is in a first section of the form, step 52. A form document format is provided wherein all general or not personally identifiable data is in a second section of the form, step 53. Provision is also made, step 54, for paper form documents with handwritten or typed entries but having the first and second sections described in steps 52 and 53. Provision is made, step 55, for scanning the manually prepared form documents of step 54 into the data entry computers. Provision is made for the assignment of unrelatable identifiers to the respective first and second section of the form document, step 56. Provision is made for transmitting the general data in the second section to one data handling provider for processing the general data in the section, step 57. Provision is made, step 58, for transmitting the personally identifiable data in the first section to a different data handling provider for processing the data in the first section completely independently of and not related to the one provider handling the general information.

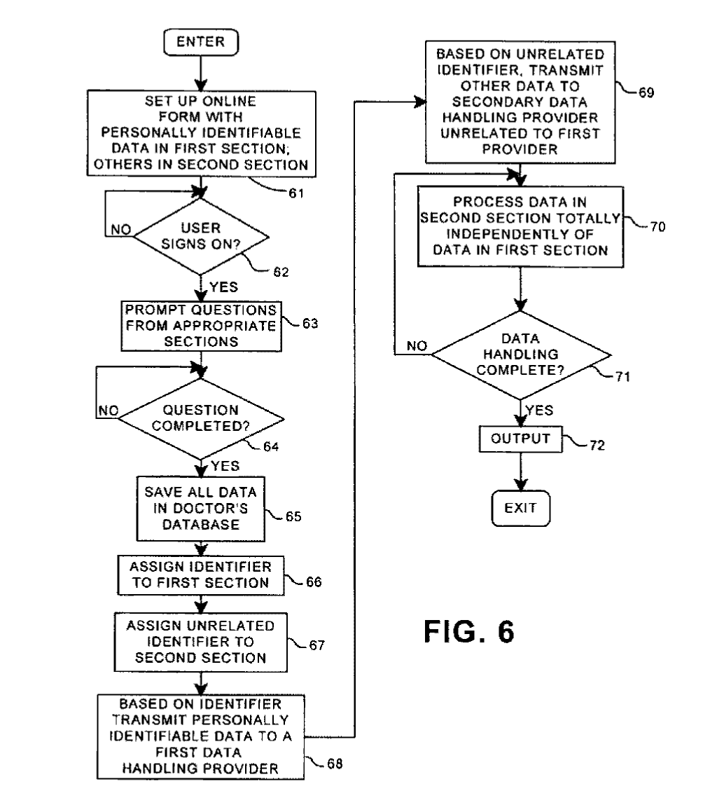

The running of the process set up in FIG. 5 will now be described with respect to the flowchart of FIG. 6. An on-line form is set up with sensitive personally identifiable entries in one section and all other entries in another section, step 61. A determination is made, step 62, as to whether or not a user has signed on. If Yes, the user is prompted for data entry in response to the questions in the first and second sections, step 63. A determination is made as to whether entries have been completed, step 64. If Yes, all of the entered data is saved at the originating facility that, in this illustrative case, will be a medical, i.e. doctor's office, step 65. An identifier is assigned to the first section, step 66. An unrelatable identifier is assigned to the second section, step 67. The term “unrelatable” is meant to describe an identifier that in and of itself cannot be related to the identifier of the first section. It is understood that with further information, which in the present embodiment is at the originating source, the doctor's office, the identifiers can be related for the purpose of correlating the data in both sections. Based upon its identifier, the personally identifiable data in the first section is transmitted to a first information handling provider, step 68. Based upon its unrelatable identifier, the other data in the second section is transmitted to a second information handling provider that is unrelatable to the first information handling provider, step 69. The data in the first and second section are processed by their respective information handling providers in total independence of each other, step 70. At appropriate points in the process, a sampling determination is made, step 71, as to whether the information handling by the respective providers is complete. If No, the process is branched back to step 70 and the information handling is continued. If Yes, appropriate output is provided by the respective information handling providers. The respective outputs of the providers do not relate the personally identifiable user-sensitive data to the general data, except where portions of the output are transmitted back to the originating medical facility that can correlate outputs from both providers.

One of the implementations of the present invention may be in application program 40 made up of programming steps or instructions resident in RAM 14, FIG. 41 of a computer or server station during various operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a network, such as the web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A data entry system for isolating personally identifiable data from other data comprising:
means for requesting the entry of user data into an entry document, wherein a first section in said entry document is for personally identifiable data and a second section in said entry document is for other data;
means for respectively transferring the first section of the document to a first data processor and the second section of the document to a second data processor;
means for processing said personally identifiable data in isolation from said other data by said first and second processors to respectively produce processed personally identifiable data and processed other data; and
means for relating the processed personally identifiable data and the processed other data in isolation from said first and second processors.

2. The data entry system of claim 1 wherein said means for processing includes:
means for assigning separate identifiers respectively to said first section and to said second section; and
means for distributing said first and second sections respectively to two separate and unrelated data handling providers.

3. The data entry system of claim 1:
wherein said entry document is a form on which user data is physically marked; and
further including means for scanning said form into the computer controlled data entry system.

4. The data entry system of claim 1:
wherein said computer system includes a computer display: and
said means for requesting the entry of user data requests user-interactive entry via said computer display.

5. The data entry system of claim 4 further including means for visually distinguishing said first data entry section from said second data section.

6. The data entry system of claim 1 further including means for transferring at least some personally identifiable data to a third data processor for processing wherein the personally identifiable data is further isolated.

7. The data entry system of claim 1 further including means for processing said other data for demographic information unrelated to said user.

8. A computer controlled data entry method for isolating personally identifiable data from other data comprising:
requesting the entry of user data into an entry document, wherein a first section in said entry document is for personally identifiable data and a second section in said entry document is for other data;
respectively transferring the first section of the document to a first data processor and the second section of the document to a second data processor;
processing said personally identifiable data in isolation from said other data by said processors to respectively produce processed personally identifiable data and processed other data; and
relating the processed personally identifiable data and the processed other data in isolation from said first and second processors.

9. The method of claim 8 wherein said processing step includes:
assigning separate identifiers respectively to said first section and to said second section; and
distributing said first and second sections respectively to two separate and unrelated data handling providers.

10. The method of claim 8:
wherein said entry document is a form on which user data is physically marked; and
further including the step of scanning said form into the computer controlled data entry system.

11. The method of claim 8:
wherein said computer system includes a computer display; and
said step of requesting the entry of user data requests user-interactive entry via said computer display.

12. The method of claim 11 further including the step of visually distinguishing said first data entry section from said second data section.

13. The method of claim 8 further including the step of processing at least some personally identifiable data by a third data processor to further isolate the personally identifiable data.

14. The data entry system of claim 1 further including processing said other data for demographic information unrelated to said user.

15. A computer program having code recorded on a computer readable storage medium for isolating personally identifiable data from other data comprising:
means for requesting the entry of user data into an entry document, wherein a first section in said entry document is for personally identifiable data and a second section in said entry document is for other data;
means for respectively transferring the first section of the document to a first data processor and the second section of the document to a second data processor;
means for processing said personally identifiable data in isolation from said other data by said first and second processors to respectively produce processed personally identifiable data and processed other data; and
means for relating the processed personally identifiable data and the processed other data in isolation from said first and second processors.

16. The computer program of claim 15 wherein said means for processing includes:
means for assigning separate identifiers respectively to said first section and to said second section; and
means for distributing said first and second sections respectively to two separate and unrelated data handling providers.

17. The computer program of claim 16:
wherein said entry document is a form on which user data is physically marked; and
further including means for scanning said form into the computer controlled data entry system.

18. The computer program of claim 15:
wherein said computer system includes a computer display; and
said means for requesting the entry of user data requests user-interactive entry via said computer display.

19. The computer program of claim 18 further including means for visually distinguishing said first data entry section from said second data section.

20. The computer program of claim 15 further including means for transferring at least some personally identifiable data to a third data processor for processing wherein the personally identifiable data is further isolated.
